(19) United States
(12) Patent Application Publication
(10) Pub. No.: US 2022/0402089 A1
(43) Pub. Date: Dec. 22, 2022

(54) POWER TOOL

(71) Applicant: Jackson Travis Wolfe, Richmond (CA)

(72) Inventor: Jackson Travis Wolfe, Richmond (CA)

(21) Appl. No.: 17/304,462

(22) Filed: Jun. 22, 2021

(51) Int. Cl. B24B 23/02; B25F 3/00; B25F 5/02

(52) U.S. Cl. CPC B24B 23/02; B25F 3/00; B25F 5/029

(57) ABSTRACT

A power tool that is configured to provide finishing of a surface of an object wherein the power tool provides movement in a first direction and a second direction. The power tool of the present invention includes a housing wherein the housing has a coupling assembly secured to the front end thereof. The rear end of the housing includes a brush compartment formed therein. A sanding member is releasably secured to the coupling assembly and includes a planar body configured to have sanding paper secured thereto. A filing member is also provided and configured to be releasably secured to the coupling assembly. The filing member includes a rectangular body having formations on the outer surface thereof. A three-way switch provides control to move the sanding member and the filing member in the first and second direction. A battery power supply is disposed in the housing.

### FIELD OF THE INVENTION

The present invention relates generally to tools, more specifically but not by way of limitation, a power tool that is designed to facilitate intricate woodworking tasks wherein the power tool of the present invention includes mechanisms and movement to provide reciprocating pad sanding and a wand sander.

### BACKGROUND

Woodworking tools are well known in the art. Woodworking has evolved over the year to include utilization of specially designed power tools that provide an improved ability to execute the desired task needed. This includes advancements in tools such as but not limited to power drills and nail guns. During construction of objects from wood such as but not limited to cabinets, procedures such as but not limited to sanding and filing are important to ensure a desired finish outcome for the project. Sanding is executed utilizing various types of sandpaper and the sanding can be done by hand or with the use of tools. Common types of sanding tools are belt sanders and pad sanders. Belt sanders are typically utilized for rough surfaces and typically provide a fairly aggressive technique. Another more common type of sanding tool is pad sanders.

As is known in the art pad sanders utilize a reciprocating motion to drive a pad having secured thereto. Pad sanders are often provided in two to three sizes and typically accommodate a quarter or a third of a full sheet of sandpaper. One problem when working on certain projects is the inability for a conventional pad sander to reach in the area needed. Another tool utilized commonly is a file. Files are utilized in hard to reach areas and are often operated by hand. A benefit would be provided to provide the ability to improve pad sanding capabilities and further combine with an ability to utilize a file wherein a file and/or pad could be power operated.

It is intended within the scope of the present invention to provide a power tool that employs a quick connect apparatus that facilitates the ability to couple a wand style pad sander and various files.

### SUMMARY OF THE INVENTION

It is the object of the present invention to provide a power tool configured to provide the ability to quickly change between a sanding and filing task wherein the present invention employs a quick connect coupler to couple and de-couple the sanding or filing members.

Another object of the present invention is to provide a tool operable to assist in the sanding or filing of an object wherein the present invention includes a housing wherein the housing has an electric motor therein.

A further object of the present invention is to provide a power tool configured to provide the ability to quickly change between a sanding and filing task wherein the housing of the present invention includes a first end having a quick connect mechanism secured thereto wherein the quick connect mechanism is operable to couple to the sanding and filing members.

Still another object of the present invention is to provide a tool operable to assist in the sanding or filing of an object wherein the present invention wherein the present invention includes a wand style pad sander that is provided in alternate sizes.

An additional object of the present invention is to provide a power tool configured to provide the ability to quickly change between a sanding and filing task that further includes a filing member wherein the filing member is provided in alternate sizes.

Yet a further object of the present invention is to provide a tool operable to assist in the sanding or filing of an object wherein the present invention includes an integrated brush and brush compartment in the second end of the housing.

Another object of the present invention is to provide a power tool configured to provide the ability to quickly change between a sanding and filing task wherein the pad sand member includes an extended support arm.

An alternate object of the present invention is to provide a tool operable to assist in the sanding or filing of an object wherein the present invention a lithium ion power supply.

An alternative objective of the present invention is to provide a power tool configured to provide the ability to quickly change between a sanding and filing task wherein the motor is operable to provide movement of the pad and filing members in both a lateral direction and a back and forth direction.

Another object of the present invention is to provide a tool operable to assist in the sanding or filing of an object wherein the movement of pad sanding member and filing member is controlled via a three-way switch.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention with a pad sanding member secured thereto; and

FIG. 2 is a perspective view of the present invention with a filing member secured thereto.

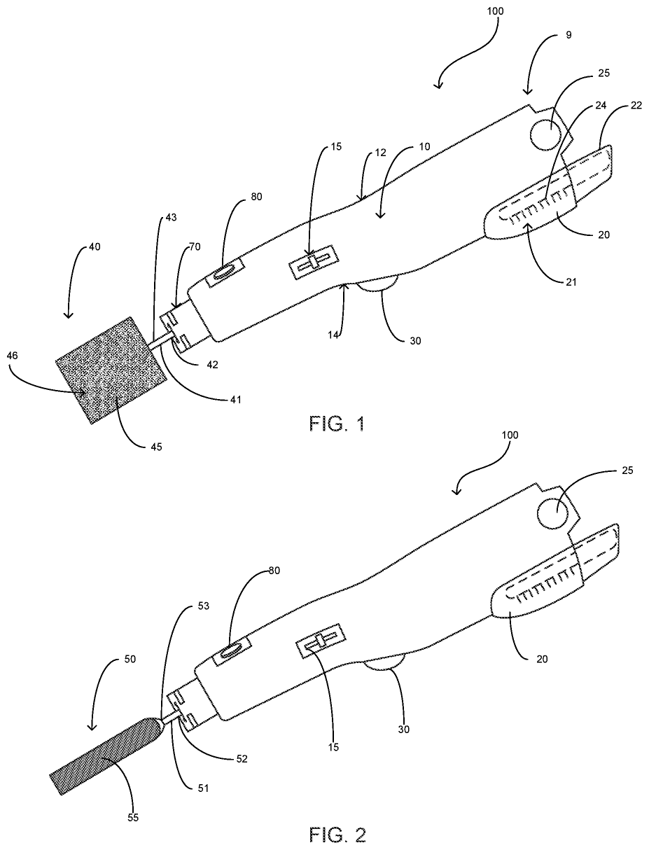

### DETAILED DESCRIPTION

References now to the drawings submitted herewith, wherein various elements depicted therein are not necessarily drawn to scale and wherein through the views and figures like elements are referenced with identical reference numerals, there is illustrated a power tool 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring to the Drawings submitted as a part hereof, the power tool 100 includes a housing 10. The housing 10 is manufactured from a durable lightweight material such as but not limited to plastic. The housing 10 is generally elongated cylindrical in shape having an upper curved formation 12 and a lower curved formation 14 in the exterior thereof. The housing 10 is manufactured so as to have a diameter that can fit into the palm of a human hand and the upper curved formation 12 and lower curved formation 14 provide a shape that provides for improved control of the power tool 100 during use thereof. Formed into the housing 10 is switch 15 wherein the switch 15 is oriented so as to be proximate the thumb of the hand engaged with the power tool 100. The switch 15 is a three-way switch having a first position, a second position and a third position. In the first position the switch 15 is located in a midpoint and the power tool 100 is non-operational. In the second position, the switch 15 is moved forward and in this position the power tool 100 provides a back and forth movement of the sanding member 40 or filing member 50. In the third position, the switch 15 is moved rearward and in this position the power tool 100 will provide a lateral side to side movement of the sanding member 40 or filing member 50. It should be understood within the scope of the present invention that the power tool 100 could provide various speeds of each of the aforementioned movements.

Integrally formed into the housing 10 proximate the second end 9 thereof is the brush compartment 20. The brush compartment 20 includes an interior volume 21 that is of suitable size so as to accommodate a portion of a brush therein. The brush compartment 20 further includes a cap 22 releasably secured thereto that provides access to the interior volume 21 and further keeps contaminants such as but not limited to dust from egressing into the interior volume 21. A brush 24 is stored within the interior volume 21 and is configured to be available and utilized to dust/brush an object on which the power tool 100 is being utilized to finish the surface thereof. It should be understood within the scope of the present invention that the brush compartment 20 could be provided in alternate sizes so as to accommodate various styles of brushes. A battery slot 25 is formed in the housing 10 proximate the second end 9 adjacent to the brush compartment 20. The battery slot 25 is configured to receive therein a battery such as but not limited to a twenty-volt lithium ion battery. The battery is operable to provide the necessary power to the electric motor (not particularly illustrated herein) that drives the movement of the sanding member 40 and filing member 50. While a battery powered motor is preferred, it should be understood within the scope of the present invention that the power tool 100 could be configured to be electrically coupled to a power outlet. The power button 30 is provided in order to transition the power tool 100 from an on position to an off position for operation thereof.

The power tool 100 provides a sanding member 40 and a filing member 50 and quick release/connection thereof so as to provide alternate types of finishing techniques that may be desired by a user depending upon the object being worked on or the finish level desired. The sanding member 40 includes support arm 41 wherein the support arm 41 has a first end 42 and a second end 43. The support arm 41 is manufactured from a durable rigid material such as but not limited to metal. The support arm 41 is operably coupled with the coupling assembly 70. Specifically, the first end 42 of the support arm 41 is journaled into the coupling assembly 70 and releasably secured therein. The support arm 41 is released and/or secured to the coupling assembly 70 via lock button 80. It should be understood within the scope of the present invention that the support arm 41 could be configured with alternate elements that are operable to facilitate the connection to the coupling assembly 70. The sanding member 40 further includes body member 45 that is square in shape and planar in manner. The body member 45 includes lower surface 46 that is configured to releasably secure a piece of sanding paper thereto. It should be understood within the scope of the present invention that the body member 45 could be provided in alternate shapes and sizes. More specifically but not by way of limitation, the body member 45 of the sanding member 40 could be triangular in shape so as to provide effective finishing of corners and similar structures. Furthermore, it should be understood within the scope of the present invention that the sanding paper could be secured to the lower surface 46 utilizing a variety of techniques and/or elements.

The power tool 100 includes a filing member 50 and is operably connected to the coupling assembly 70 as previously discussed herein. The filing member 50 includes support arm 51 wherein the support arm 51 has a first end 52 and a second end 53. The support arm 51 is manufactured from a durable rigid material such as but not limited to metal. The support arm 51 is operably coupled with the coupling assembly 70. Specifically, the first end 52 of the support arm 51 is journaled into the coupling assembly 70 and releasably secured therein. The support arm 51 is released and/or secured to the coupling assembly 70 via lock button 80. It should be understood within the scope of the present invention that the support arm 51 could be configured with alternate elements that are operable to facilitate the connection to the coupling assembly 70. The filing member 50 further includes body member 55 that is rectangular in shape and planar in manner. The body member 55 is manufactured from metal and includes formations 56 in the surface thereof that provide finishing of an object when engaged therewith. It should be understood within the scope of the present invention that the body member 55 could be provided in alternate shapes and sizes and further have alternate types of formations so as to provide varying levels of filing ability.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A power tool that is configured to provide finishing of a surface of an object wherein the power tool comprises:
a housing, said housing having an exterior wall defining the shape thereof, said housing having an interior volume, said housing having a diameter configured to be accommodate by a human hand, said housing having a first end and a second end;
a coupling assembly, said coupling assembly operably coupled to said housing proximate said first end thereof, said coupling assembly configured to releasably secure finishing members therein;
a first finishing member, said first finishing member configured to be releasably secured to said coupling assembly, said first finishing member including a support arm, said support arm being configured to be inserted into said coupling assembly, said first finishing member further including a body, said body of said first finishing member being planar in manner; and
wherein the first finishing member is moved in a first direction or a second direction in order to facilitate finishing of the surface of the object.

2. The power tool that is configured to provide finishing of the surface of the object as recited in claim 1, and further including a second finishing member, said second finishing member having a support arm, said support arm of said second finishing member having a first end and a second end, said second finishing member having a body secured to said second end of said support arm of said second finishing member, said body being elongated and rectangular in shape.

3. The power tool that is configured to provide finishing of the surface of the object as recited in claim 2, wherein the body of said second finishing member includes an outer surface, said outer surface of said body of said second finishing member having formations thereon operable to provide finishing of the surface of the object.

4. The power tool that is configured to provide finishing of the surface of the object as recited in claim 3, wherein said housing further includes a brush compartment, said brush compartment being formed in said housing proximate said second end, said brush compartment having an interior volume configured to receive and store a brush therein.

5. The power tool that is configured to provide finishing of the surface of the object as recited in claim 4, wherein said body of said first finishing member includes a lower surface, said lower surface configured to have a piece of sandpaper releasably secured thereto.

6. The power tool that is configured to provide finishing of the surface of the object as recited in claim 5, and further including a three-way switch, said three-way switch configured to provide selection between the first direction and the second direction of movement for the first finishing member and second finishing member.

7. The power tool that is configured to provide finishing of the surface of the object as recited in claim 6, wherein the first direction of movement is a back and forth movement.

8. The power tool that is configured to provide finishing of the surface of the object as recited in claim 7, wherein the second direction of movement is a side to side movement.

9. The power tool that is configured to provide finishing of the surface of the object as recited in claim 8, wherein the body of the second finishing member is a metal file.

10. The power tool that is configured to provide finishing of the surface of the object as recited in claim 9, wherein said brush compartment further includes a cap member, said cap member configured to cover an opening providing access to the interior volume of the brush compartment.

11. A power tool that is configured to provide finishing of a surface of an object wherein the power tool is operable to provide movement of a finishing member in a first direction and a second direction wherein the power tool comprises:
a housing, said housing having an exterior wall defining the shape thereof, said housing having an interior volume, said housing having an upper curved formation and a lower curved formation in the exterior wall, said housing having a first end and a second end;
a sanding member, said sanding member configured to be releasably secured to the power tool, said sanding member including a support arm, said sanding member further including a body, said body of said sanding member being planar in manner, said body of said sanding member having a lower surface, said lower surface configured to releasably secure a piece of sandpaper thereto;
a filing member, said filing member configured to be releasably secured to the power tool, said filing member having a support arm, said support arm of said filing member having a first end and a second end, said filing member having a body integrally formed with said second end of said support arm of said filing member, said body of said filing member having formations on an outer surface thereof; and
a coupling assembly, said coupling assembly configured to provide releasably securing of said sanding member and said filing member to the power tool and wherein the sanding member and filing member are operable to be moved in a first direction and a second direction.

12. The power tool that is configured to provide finishing of the surface of the object as recited in claim 11, wherein said housing further includes a brush compartment, said brush compartment being formed in said housing proximate said second end, said brush compartment having an interior volume configured to receive and store a brush therein, said brush compartment further having a cap member operable to cover an opening providing access to said interior volume of said brush compartment.

13. The power tool that is configured to provide finishing of the surface of the object as recited in claim 12, and further including a three-way switch, said three-way switch configured to provide selection between the first direction and the second direction of movement for the sanding member and the filing member.

14. The power tool that is configured to provide finishing of the surface of the object as recited in claim 13, wherein the housing further includes a battery slot operable to receive a battery therein.

15. The power tool that is configured to provide finishing of the surface of the object as recited in claim 14, wherein the second direction of movement is a side to side movement.

16. The power tool that is configured to provide finishing of the surface of the object as recited in claim 15, wherein the first direction of movement is a back and forth movement.
